(19) United States
(12) Patent Application Publication
(10) Pub. No.: US 2019/0382639 A1
(43) Pub. Date: Dec. 19, 2019

(54) EXHAUST REDUCTION COMPOSITION

(71) Applicant: Jae Soo KIM, Jeonju-si (KR)

(72) Inventor: Jae Soo KIM, Jeonju-si (KR)

(21) Appl. No.: 16/488,226

(22) PCT Filed: Feb. 23, 2018
(86) PCT No.: PCT/KR2018/002233

§ 371 Date: Aug. 22, 2019

(30) Foreign Application Priority Data
Feb. 23, 2017 (KR) 10-2017-0023929

(51) Int. Cl. C09K 5/20; F01N 3/20

(52) U.S. Cl. CPC C09K 5/20; F01N 3/2006

(57) ABSTRACT

The present invention relates to an exhaust reduction composition containing silicon carbide particles, alumina particles, and neodymium particles. When the exhaust reduction composition according to the present invention is mixed with the cooling water of an internal combustion engine, there is an advantage of enabling the discharge of exhaust material to be reduced.

### TECHNICAL FIELD

The present invention relates to a composition mixed with cooling water of an engine to remarkably reduce exhaust gas exhausted from the engine.

### BACKGROUND ART

An engine generally seen around surroundings refers to a device that obtains a desired output by using fossil fuels such as gasoline as a driving source. The most important task in researches on the above engine is to use the minimum fuels with the maximum fuel efficiency. In addition, researches on reducing pollutants exhausted by combustion in the engine have been conducted due to recent global warming caused by greenhouse gas emissions and air pollution caused by fine dusts.

Particularly, the above researches include design changes of the engine itself, improvement of fuel purity, and development of fuel additives. Further, researches also have been actively conducted on an auxiliary mechanism, such as cooling water that exerts an indirect effect on the engine.

The cooling water originally aims at absorbing heat generated during operation of the engine to prevent a temperature of the engine from being excessively high. However, researches also has actively conducted recently on technologies for preventing incomplete combustion or the like by adding additives to the cooling water exerting an indirect effect on the operation of the engine to reduce exhaust gas exhausted from the engine. For example, Korean Patent Registration No. 10-1010935 discloses an antifreeze additive composition capable of reducing exhaust gas matter, but the reduction of exhausting hydrocarbons is insignificant.

### DETAILED DESCRIPTION OF THE INVENTION

### Technical Problem

An object of the present invention is to provide an exhaust reduction composition for remarkably reducing pollutants exhausted from an internal combustion engine such as nitrogen oxides, carbon monoxide, and unreacted hydrocarbons.

### Technical Solution

The exhaust reduction composition according to the present invention includes: silicon carbide particles, alumina particles, and neodymium particles.

The exhaust reduction composition according to an embodiment of the present invention may include at least one selected from germanium, elvan, rock crystal and jade.

The exhaust reduction composition according to an embodiment of the present invention may further include at least one or two selected from lanthanum, cerium, samarium, titanium and zirconium.

The exhaust reduction composition according to an embodiment of the present invention may include 50 parts to 1000 parts by weight of the silicon carbide particles based on 100 parts by weight of the neodymium particles.

The exhaust reduction composition according to an embodiment of the present invention may include 10 parts to 500 parts by weight of the alumina particles based on 100 parts by weight of the neodymium particles.

### Advantageous Effects of the Invention

The exhaust reduction composition according to the present invention simultaneously includes silicon carbide particles, aluminum particles, and neodymium particles so that exhaust gas exhausted from the internal combustion engine, in particular hydrocarbons, can be remarkably reduced.

### DESCRIPTION OF THE DRAWINGS

Hereinafter, an exhaust reduction composition according to the present invention will be described in detail with examples. However, the following examples are merely illustrative of the present invention and the present invention is not limited to the following examples. In addition, terms used in the present invention are based on the general level of knowledge of those skilled in the art unless otherwise defined in the present invention, and the description for well-known technology that may obscure essence of the invention will be omitted.

The present invention relates to an exhaust reduction composition including silicon carbide particles, alumina particles, and neodymium particles.

When the exhaust reduction composition according to the present invention is mixed with cooling water for an internal combustion engine, exhaust gas matter in gas exhausted from the internal combustion engine can be remarkably reduced. Particularly, when the internal combustion engine is operated after mixing the exhaust reduction composition according to the present invention with the cooling water for the internal combustion engine, emissions of nitrogen oxides, carbon dioxides and unreacted hydrocarbons can be remarkably reduced.

In regard to the exhaust reduction composition according to the present invention, the exhaust gas refers to hydrocarbons, carbon monoxide, nitrogen oxides and carbon dioxides. The internal combustion engine refers to a device that produces energy by combusting fuels therein. In particularly, the internal combustion engine may be used for a vehicle or a ship, but is not limited thereto. In addition, the unreacted hydrocarbons collectively refer to compounds having a carbon-hydrogen bond after incompletely combusted in the internal combustion engine.

In other words, the exhaust reduction composition according to the present invention simultaneously includes silicon carbide particles, alumina particles and neodymium particles so that the unreacted hydrocarbons, which are one of pollutants exhausted from the internal combustion engine, can remarkably reduced. The hydrocarbons are one of the greenhouse gases that cause global warming and have a higher global warming index relative to carbon dioxide, such that the reduction of the unreacted hydrocarbons can prevent the global warming. Particularly, diameters of the silicon carbide particles, the alumina particles, and the neodymium particles independently may be 1 μm to 200 μm, particularly 10 μm to 100 μm.

Particularly, the exhaust reduction composition according to an embodiment of the present invention may include 50 parts to 1000 parts by weight of the silicon carbide particles based on 100 parts by weight of the neodymium particles. When the exhaust reduction composition according to an embodiment of the present invention includes the neodymium particles and the silicon carbide particles in the above range, the emission of the unreacted hydrocarbons can be reduced by up to 85% compared to the case without the exhaust reduction composition.

In addition, the exhaust reduction composition according to an embodiment of the present invention may include 200 parts to 400 parts by weight of alumina particles based on 100 parts by weight of the neodymium particles. When the exhaust reduction composition according to an embodiment of the present invention includes the silicon carbide particles, the alumina particles, and the neodymium particles in the above range, in addition to the above-described reduction of the unreacted hydrocarbons, thermal conductivity of the entire cooling water increases due to a synergistic effect even after a small amount of alumina particles is mixed with the cooling water, so that a heat absorption, which is an original function of the cooling water, can also be efficiently performed. As a result, the exhaust gas prevention effect of the internal combustion engine can be improved.

The exhaust reduction composition according to an embodiment of the present invention may include at least one selected from germanium, elvan, rock crystal and jade. When at least one selected from the germanium, elvan, rock crystal and jade is added to the cooling water, it appears that complete combustion of the fuel is assisted by promoting fuel combustion of the internal combustion engine although the cause is unknown, so that the combustion efficiency increases. Particularly, when the exhaust reduction composition according to an embodiment of the present invention includes at least one selected from the germanium, elvan, rock crystal and jade together with the above-described silicon carbide particles, alumina particles, and neodymium particles, the synergistic effect is specifically caused so that the fuel combustion in the internal combustion engine can be promoted. As a result, the above combustion promotion can further reduce the emission of exhaust gas matter such as carbon monoxide.

In addition, the exhaust reduction composition according to an embodiment of the present invention may include 10 parts to 200 parts by weight of germanium, elvan, rock crystal or jade based on 100 parts by weight of neodymium particles, respectively, and the above-described complete combustion promotion effect may be maximized in the above range. When the germanium, elvan, rock crystal and jade have a particulate shape that may be uniformly mixed with the cooling water, the germanium, elvan, rock crystal and jade may independently have a diameter of 1 μm to 200 μm although there is no limit, and particularly, the diameter may be 10 μm to 100 μm.

Further, the exhaust reduction composition according to an embodiment of the present invention includes all the germanium, elvan, and rock crystal in the above range together with the silicon carbide particles, alumina particles, and neodymium particles, the emissions of nitrogen oxides, carbon dioxide and unreacted hydrocarbons can be reduced as described above, and the emission of nitrogen oxide can also be reduced by a certain amount, so that the emission of greenhouse gas can be reduced more efficiently.

The exhaust reduction composition according to an embodiment of the present invention may further include at least one or two selected from lanthanum, cerium, samarium, titanium and zirconium, and more particularly, may include at least one or two metal particles selected from lanthanum, cerium, titanium and zirconium. When the metal particles are added, the combustion efficiency is specifically improved although the cause is unknown. From an experiment, it was observed that an aggregation of the exhaust reduction composition was remarkably reduced by using the metal particles, which may be resulted due to the effect induced by the aggregation decrease and the uniform dispersion.

Particularly, the exhaust reduction composition according to an embodiment of the present invention may include 30 parts to 100 parts by weight of at least one or two metal particles selected from lanthanum, cerium, samarium, titanium and zirconium based on 100 parts by weight of neodymium. Within the above range, the aggregation of metal particles in the cooling water can be prevented and the combustion efficiency can be maximized.

The exhaust reduction composition may include the lanthanum, cerium, samarium, titanium and zirconium in a particulate shape. The diameter of the particles may be independently 1 μm to 200 μm, preferably 10 μm to 100 μm. Within the above range, the aggregation of particulate shape can be prevented and thus the advantageous effects of the present invention can be maximized.

The exhaust reduction composition may be added differently according to a type of the internal combustion engine and an amount of the cooling water, and may be mixed by 30 g to 300 g per 100 liters of cooling water based on a vehicle. In addition, the mixture of the exhaust reduction composition has no limit when a mechanism capable of mixing the exhaust reduction composition with the cooling water contained in the internal combustion engine is used, the exhaust reduction composition may be mixed with water or a commercially available antifreeze so as to be added in the form of a dispersion or added in the form of a capsule soluble in the cooling water. When the capsule is a substance soluble in the cooling water the capsule, particularly, may be gelatin, collagen or a mixture thereof although there is no limit.

The exhaust reduction composition according to an embodiment of the present invention may be mixed with alkaline ionized water dispersed, and then mixed with the cooling water. The alkaline ionized water is also called alkaline electrolytic water, which is obtained by applying electric power to ordinary mineral water, tap water or ground water, and the water collected at a cathode is called alkaline ionized water. When the exhaust reduction composition is dispersed using the alkaline ionized water and then mixed with the cooling water, the exhaust reduction effect by the exhaust reduction composition according to an embodiment of the present invention can be exhibited for a long time, and a lifespan of the cooling water can be expanded to prevent the vehicle from being damaged due to corrosion even when the vehicle is used for a long time. The alkaline ionized water may be added to the cooling water at the ratio of 1:1 to 1:3 by weight between the exhaust reduction composition and the alkaline ionized water.

In addition, the exhaust reduction composition according to an embodiment of the present invention may be added to the cooling water after mixed with an amphipathic solvent. When the exhaust reduction composition according to an embodiment of the present invention is added to the cooling water after mixed with the amphiphilic solvent, the above-described exhaust reduction efficiency can further increases, the exhaust reduction composition can be easily dispersed in the cooling water, and scale due to the cooling water can be prevented after the exhaust reduction composition is added. Particularly, when the amphiphilic solvent is a solvent that may be uniformly mixed with the cooling water, the amphiphilic solvent, particularly, may be a protic solvent or an aprotic solvent although there is no limit. The protic solvent may be a monovalent or polyvalent alcohol having 3 to 7 carbon atoms or a mixture thereof. The aprotic solvent may be at least one or two selected from acetone, N-methylpyrrolidone (NMP), tetrahydrofuran, dimethylformamide (DMF), dimethylsulfoxide (DMSO) and diethylacetamine (DMAc). The amphiphilic solvent according to an embodiment of the present invention may be a mixed solvent in which the protic solvent is mixed with the aprotic solvent. Although there is no limit to the mixing ratio, 10 parts to 500 parts by weight of the aprotic solvent may be mixed with respect to 100 parts by weight of the protic solvent. When the protic solvent and the aprotic solvent, which indicate amphiphilic properties, are mixed, the formation of the solvents mixed in the cooling water can be maintained uniformly even when a temperature of the cooling water changes due to external factors such as seasonal changes or operations of the internal combustion engine, in addition to the above-described effects of exhaust reduction, dispersion, and scale prevention.

In addition, 10 parts to 1000 parts by weight, particularly 20 parts to 300 parts by weight of the amphiphilic solvent may be mixed based on 100 parts by weight of the exhaust reduction composition. Within the above range, the scale prevention effect can be maximized without deteriorating the exhaust reduction effect.

Hereinafter, the present invention will be described in detail with examples. The following examples are merely illustrative to understand the present invention and the present invention is not limited to the examples described below.

### EXAMPLE 1

An exhaust reduction composition was prepared by mixing 50 g of neodymium particles having an average diameter of 0.5 μm, 250 g of silicon carbide particles having an average diameter of 35 μm, 100 g of alumina particles having an average diameter of 25 μm, 10 g of amethyst powder having an average diameter of 35 μm, 50 g of germanium particles having an average diameter of 80 μm, and 50 g of elvan particles having an average diameter of 75 μm.

The prepared exhaust reduction composition is mixed with 1 liter of alkaline ionized water to prepare an exhaust reduction composition dispersion, and then the exhaust reduction composition dispersion is irradiated with ultrasonic waves for 20 minutes so as to be uniformly dispersed.

### EXAMPLE 2

An exhaust reduction composition dispersion was prepared in the same manner as in Example 1, but was prepared by mixing 300 g of silicon carbide particles and 50 g of alumina particles instead of 350 g of silicon carbide particles and 100 g of alumina particles.

### EXAMPLE 3

An exhaust reduction composition dispersion was prepared in the same manner as in Example 1, but was prepared by adding 300 g of neodymium particles instead of 50 g.

### EXAMPLE 4

An exhaust reduction composition dispersion was prepared in the same manner as in Example 1, but was prepared by mixing other components except for amethyst.

### EXAMPLE 5

An exhaust reduction composition dispersion was prepared by mixing 100 g of the exhaust reduction composition dispersion prepared in the manner as in Example 1 with 50 g of DMSO and 50 g of n-pentanol, and irradiating the mixture with ultrasonic waves for 20 minutes to be uniformly dispersed.

### COMPARATIVE EXAMPLE 1

An exhaust reduction composition dispersion was prepared in the same manner as in Example 1, but was prepared by mixing other components except for silicon carbide.

### COMPARATIVE EXAMPLE 2

An exhaust reduction composition dispersion was prepared in the same manner as in Example 1, but was prepared by mixing other components except for alumina particles.

### COMPARATIVE EXAMPLE 3

An exhaust reduction composition dispersion was prepared in the same manner as in Example 1, but was prepared by mixing other components except for neodymium particles.

### COMPARATIVE EXAMPLE 4

After the exhaust reduction composition was prepared by mixing 100 g of elvan particles having an average diameter of 75 μm, 5 g of neodymium particles having an average diameter of 0.5 μm, 10 g of tourmaline powder having an average diameter of 0.5 μm, 5 g of zirconium particles having an average diameter of 0.1 μm, and strontium particles having an average diameter of 0.1 μm, an exhaust reduction composition dispersion was prepared by mixing the exhaust reduction composition with 1 liter of alkaline ionized water. [Measurement of Exhaust Gas Reduction Rate of Exhaust Reduction Composition]

The exhaust gas reduction rates of the examples and the comparative examples were measured using a vehicle which is EF Sonata (1836 cc) model of the year 2000. Particularly, after the cooling water that has already been injected was removed, washing was performed by idling at least two times using water. Then, 9.8 L of cooling water obtained by mixing an antifreeze (a four season antifreeze made by JW Industry company) with water at the volume ratio of 1:1, and 170 ml of the exhaust reduction composition dispersion according to Examples or Comparative Examples were injected into a vehicle, the vehicle is driven for 5 km, and then the reduction rate of the exhaust gas matter relative to the exhaust before adding the exhaust reduction composition is calculated based on Equation 1. Table 1 shows the results.

Reduction rate of exhaust gas matter=V1/(V0−V1) [Equation 1]

V0 refers to an emission amount of each exhaust gas matter before inputting the exhaust reduction composition, and V1 refers to an emission amount of each exhaust gas matter after inputting the exhaust reduction composition.

TABLE 1

| | Example | | | | | Comparative Example | | | |
|---|---|---|---|---|---|---|---|---|---|
| | 1 | 2 | 3 | 4 | 5 | 1 | 2 | 3 | 4 |
| Nitrogen oxide | 43.4% | 40.7% | 41.8% | 29.4% | 45.7% | 26.6% | 27.2% | 15.4% | 25.4% |
| carbon monoxide | 72.6% | 71.1% | 64.7% | 66.2% | 75.3% | 37.6% | 42.1% | 40.5% | 34.1% |
| Hydrocarbons | 80.4% | 50.7% | 77.6% | 78.4% | 80.6% | 7.1% | 11.5% | 13.4% | 8.7% |

[Measurement of Fuel Efficiency Improvement of Exhaust Reduction Composition]

The test was conducted using a vehicle, EF Sonata (1836 cc) model of the year 2000. Relative to exhaust before inputting the exhaust reduction composition according to Example 1, the fuel efficiency after inputting the exhaust reduction composition according to Example 1 and driven for 5 km was compared. As a result, it was confirmed that the fuel efficiency of the vehicle increased by 12.6% after injecting the exhaust reduction composition according to Example 1.

[Measurement of Thermal Conductivity]

Thermal conductivities of the exhaust reduction composition dispersions prepared in Example 1, Example 3 and Comparative Example 1 were measured at 20° C., and shown in Table 2.

TABLE 2

| | | | Comparative |
|---|---|---|---|
| | Example 1 | Example 3 | Example 1 |
| Thermal Conductivity (W/mK) | 0.354 | 0.321 | 0.308 |

The present invention has been described with reference to limited examples and particular items, and it shall be understood that the above description has been merely provided for further understanding the invention, the present invention is not limited to the examples. It will be understood by those skilled in the art that various changes and modifications may be carried out from the above-mentioned description.

Accordingly, the idea of the invention should not be determined by the aforementioned examples, and the following claims as well as all modifications or variations belonging to the equivalents of the claims will be within the scope of the invention.

1. An exhaust reduction composition including a silicon carbide particle, an alumina particle, and a neodymium particle.

2. The exhaust reduction composition of claim 1, further including at least one selected from germanium, elvan, rock crystal and jade.

3. The exhaust reduction composition of claim 1, further including at least one or two selected from lanthanum, cerium, samarium, titanium and zirconium.

4. The exhaust reduction composition of claim 1, wherein the exhaust reduction composition includes 500 parts to 1000 parts by weight of the silicon carbide particle based on 100 parts by weight of the neodymium particle.

5. The exhaust reduction composition of claim 4, wherein the exhaust reduction composition includes 10 parts to 500 parts by weight of the alumina particle based on 100 parts by weight of the neodymium particle.
